(19) United States
(12) Patent Application Publication
(10) Pub. No.: US 2021/0347943 A1
(43) Pub. Date: Nov. 11, 2021

(54) PROCESS FOR PRODUCING POLYARYLENE ETHER NITRILE WITH EFFICIENTLY RECOVERING N-METHYLPYRROLIDONE SOLVENT

(71) Applicant: University of Electronic Science and Technology of China, Chengdu (CN)

(72) Inventors: Xiaobo LIU, Chengdu (CN); Mingzhen XU, Chengdu (CN); Kun JIA, Chengdu (CN); Lifen TONG, Chengdu (CN)

(73) Assignee: University of Electronic Science and Technology of China, Chengdu (CN)

(21) Appl. No.: 16/992,115

(22) Filed: Aug. 13, 2020

(30) Foreign Application Priority Data
May 9, 2020 (CN) 202010388629.3

(51) Int. Cl. C08G 65/40; C08G 65/46

(52) U.S. Cl. CPC C08G 65/4093; C08G 2650/64; C08G 65/46; C08G 65/4006

(57) ABSTRACT

A process for producing polyarylene ether nitrile, in which an N-methylpyrrolidone solvent can be efficiently recovered. The process includes the following steps: mixing N-methylpyrrolidone, potassium carbonate, 2,6-dichlorobenzonitrile, dihydric phenol and toluene, and carrying out a dehydration reaction and a polymerization reaction in sequence to obtain a high-viscosity polyarylene ether nitrile solution; then pelletizing and conveying polyarylene ether nitrile particles together with methanol to a primary vibrating screen to complete a primary replacement of N-methylpyrrolidone; then using a secondary vibrating screen to complete a secondary replacement of the solvent; subsequently, grinding the polyarylene ether nitrile particles and carrying out an extraction with methanol, and then centrifuging, washing with water and drying to obtain purified polyarylene ether nitrile powder; and finally distilling replacement liquid and centrifugation liquid to separate methanol from N-methylpyrrolidone.

### CROSS REFERENCE TO THE RELATED APPLICATIONS

This application is based upon and claims priority to Chinese Patent Application No. 202010388629.3, filed on May 9, 2020, the entire contents of which are incorporated herein by reference.

### TECHNICAL FIELD

The present invention belongs to the technical field of special polymer production, and in particular relates to a process for producing polyarylene ether nitrile, in which an N-methylpyrrolidone solvent can be efficiently recovered.

### BACKGROUND

Polyarylene ether nitrile, belonging to special aromatic ether polymers, is a kind of thermoplastic polymers obtained by nucleophilic substitution condensation polymerization of aromatic dihydric phenol, potassium carbonate and benzonitrile. Its performance mainly depends on the molecular weight of the polymer formed. Therefore, the pursuit of high molecular weight and narrow molecular weight distribution is currently the research goal of most researchers. However, the high content of benzene ring and rigid segment in the molecular structure of polyarylene ether nitrile make the polyarylene ether nitrile extremely difficult to dissolve in most organic solvents, and a large amount of high boiling point solvents (N-methylpyrrolidone) are needed in the synthesis process to dissolve the raw materials of the reaction to ensure that the polymerization process is complete and thorough. In addition, in the early process, a large amount of N-methylpyrrolidone solvent needs to be added to a polymerization kettle after a polymerization reaction is completed to dilute high-viscosity solution system, so as to meet the requirements of subsequent precipitation, washing and separation. In summary, the use of large amounts of N-methylpyrrolidone solvent not only increases the economic cost, but also brings a problem in solvent recovery. At the same time, the toxic side effect of the N-methylpyrrolidone solvent may also bring great pressure to environmental protection and green production.

In the recent research on the production process of polyarylene ether nitrile, research scholars have proposed a continuous separation and purification technology, in which the technical route of using large amounts of N-methylpyrrolidone in the separation and purification process of polyarylene ether nitrile products has been improved, which reduces the use of N-methylpyrrolidone solvent to a certain extent, and relieves the pressure on solvent recovery. The above process, however, inevitably mixes the N-methylpyrrolidone solvent with the cooling liquid and the extraction agent because the cooling liquid and the extraction agent are used to repeatedly extract and replace the N-methylpyrrolidone solvent in the process of powder transfer and centrifugation. This will result in great difficulty in separation of co-mixing solvent system and increased processing steps. Especially in the process of repeatedly washing the powder with water in the extraction kettle, N-methylpyrrolidone will form a co-dissolving system with water, which will further increase the difficulty of solvent recovery and reduce the recovery efficiency of N-methylpyrrolidone. At present, the consumption of N-methylpyrrolidone solvent in the production process of polyarylene ether nitrile accounts for about 50% of the total cost, while the recovery efficiency of N-methylpyrrolidone solvent in the currently used process is only 50%. At the same time, the multi-stage multi-component rectification tower device used also causes a huge consumption on energy, manpower and material. Therefore, it is quite urgent to develop a simple, efficient, green and environmentally-friendly continuous production process of polyarylene ether nitrile, in which the N-methylpyrrolidone solvent can be efficiently recovered.

### SUMMARY

In view of the above prior art, the present invention provides a process for producing polyarylene ether nitrile, in which an N-methylpyrrolidone solvent can be efficiently recovered, so as to achieve the purpose of efficient recovery of N-methylpyrrolidone in the synthesis of polyarylene ether nitrile.

In order to achieve the above objective, the technical solution used by the present invention is to provide a process for producing polyarylene ether nitrile with efficiently recovering an N-methylpyrrolidone solvent, including the following steps:

S1: adding potassium carbonate and 2,6-dichlorobenzonitrile to N-methylpyrrolidone, and mixing well to obtain a reaction solution; and then adding dihydric phenol and toluene to the reaction solution, mixing well and then carrying out a dehydration reaction and a polymerization reaction in sequence to obtain a high-viscosity polyarylene ether nitrile solution;

S2: carrying out a pelletizing treatment on the high-viscosity polyarylene ether nitrile solution obtained in S1 to obtain polyarylene ether nitrile particles;

S3: conveying the polyarylene ether nitrile particles obtained in S2 together with methanol to a primary vibrating screen for vibration, and carrying out a primary replacement and recovery of N-methylpyrrolidone, wherein a volume ratio of the methanol used to N-methylpyrrolidone used during synthesis of polyarylene ether nitrile is 1-1.5:1;

S4: conveying a mixture after the vibration treatment using the primary vibrating screen to a secondary vibrating screen, and supplementally adding methanol for vibration, and carrying out a secondary replacement and recovery of N-methylpyrrolidone, wherein a volume ratio of the supplementally added methanol to the methanol added to the primary vibrating screen is 0.6-0.9:1; and then separating the polyarylene ether nitrile particles from a replacement liquid;

S5: mixing the polyarylene ether nitrile particles after the treatment in S4 and methanol in a mass ratio of 1:1.5-3, and then sending the mixture to a grinding device for grinding to obtain a polyarylene ether nitrile powder slurry;

S6: carrying out an extraction on the polyarylene ether nitrile powder slurry with methanol, then centrifuging to separate the polyarylene ether nitrile powder from a centrifugation liquid, and then carrying out water washing and drying treatments on the polyarylene ether nitrile powder in sequence to obtain purified polyarylene ether nitrile powder; and

S7: combining the replacement liquid and the centrifugation liquid, distilling to remove methanol and completing the recovery of N-methylpyrrolidone.

High-purity polyarylene ether nitrile powder can be obtained by using the method of the present invention while efficiently recovering the synthetic raw material N-methylpyrrolidone. Further, in the recovery process, only clean and environmentally-friendly methanol is used as a recycle agent, which will not affect the environment. Moreover, the method has a low cost, is easy for operation, and is suitable for large-scale production.

Methanol is an excellent organic extractant, which can fully replace N-methylpyrrolidone in polyarylene ether nitrile. Moreover, the boiling points of methanol and N-methylpyrrolidone differ greatly, and the two can be finally separated by distillation to realize the efficient recovery of N-methylpyrrolidone. In the purification process of polyarylene ether nitrile, the polyarylene ether nitrile particles are first vibrated by two-stage vibrating screens to be replaced twice separately, which not only completely replaces and removes the N-methylpyrrolidone on the surface of the polyarylene ether nitrile particles, but also can complete the replacement of the N-methylpyrrolidone solvent with as little methanol as possible, reducing the total usage amount of methanol. Then, the polyarylene ether nitrile particles are mixed with methanol for grinding, ensuring the uniformity of grinding. Besides, in the grinding process, N-methylpyrrolidone inside the polyarylene ether nitrile particles contacts with methanol and is dissolved into methanol, so that the recovery rate of N-methylpyrrolidone is improved while increasing the purity of polyarylene ether nitrile. Finally, the polyarylene ether nitrile powder slurry is extracted with methanol, and the remaining N-methylpyrrolidone enters methanol, and the purity of the powder is further improved. After the above treatment, the N-methylpyrrolidone in the polyarylene ether nitrile powder is completely replaced into methanol. Since the boiling points of methanol and N-methylpyrrolidone are significantly different, the two can be separated by distillation to achieve the purpose of recycling of N-methylpyrrolidone.

On the basis of the above technical solution, the present invention can further be improved as follows.

Further, a molar ratio of 2,6-dichlorobenzonitrile, dihydric phenol, potassium carbonate, N-methylpyrrolidone and toluene used in 51 is 1:1:1.1-1.8:2.5-3:0.5-1.25.

Further, the molar ratio of 2,6-dichlorobenzonitrile, dihydric phenol, potassium carbonate, N-methylpyrrolidone and toluene is 1:1:1.5:2.5:1.

The present invention can realize the control of the molecular weight and molecular weight distribution of the polyarylene ether nitrile product by controlling the addition amounts of the reaction raw materials and the ratio of the raw materials. By limiting the molar ratio of 2,6-dichlorobenzonitrile, dihydric phenol, potassium carbonate, N-methylpyrrolidone and toluene within the above range, a high-performance polyarylene ether nitrile polymer with a high molecular weight and a narrow distribution can be prepared, and the viscosity of the prepared high-viscosity polyarylene ether nitrile solution is 1000-2200 Pa·s.

Further, the dihydric phenol is one or more of the following dihydric phenols:

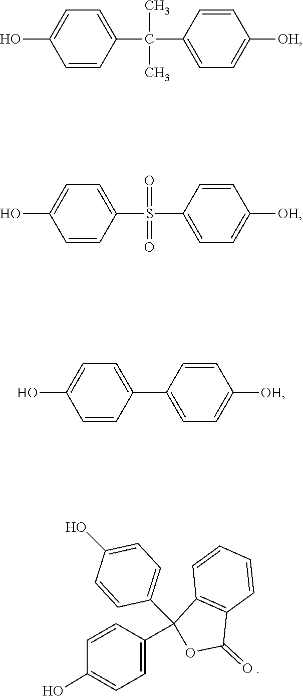 [SMILES: CC(C)(c1ccc(O)cc1)c1ccc(O)cc1 ; O=S(=O)(c1ccc(O)cc1)c1ccc(O)cc1 ; Oc1ccc(-c2ccc(O)cc2)cc1 ; O=C1OC(c2ccc(O)cc2)(c2ccc(O)cc2)c2ccccc21]

The present invention can obtain high-performance products with high molecular weights by using the above several dihydric phenols.

Further, in S1, a reaction temperature of the dehydration reaction is 140-170° C., the reaction time is 2-4 h; and a reaction temperature of the polymerization reaction is 180-200° C., and the reaction time is 3-5 h.

In the present invention, the temperature of the dehydration reaction is controlled in the range of 140-170° C., and the time is controlled within 2-4 h, which can avoid the polymerization reaction in the dehydration process, ensure the smooth progress of the dehydration reaction, and at the same time, make the dehydration reaction more thorough. The temperature of the polymerization reaction is controlled in the range of 180-200° C., and the time is controlled within 3-5 h, which can ensure that the polymerization reaction is efficiently and sufficiently carried out to obtain high molecular weight polyarylene ether nitrile.

Further, the polyarylene ether nitrile particles are cylindrical particles with a length of 0.2-0.5 mm and a diameter of 0.2-0.45 mm.

Further, a particle size of the polyarylene ether nitrile powder is 150-300 mesh.

polyarylene ether nitrile is ground into powder with a smaller particle size, and the contact area thereof with methanol is increased, which is helpful for the subsequent purification. Moreover, the products with smaller particle sizes are not easy to wrap more reaction solvent and potassium carbonate, and high-purity products can be prepared after the extraction and water washing processes.

Further, the extraction and centrifugation are repeated three times in S6.

Further, in S6, an extraction temperature is 20-25° C., the extraction time is 10-30 min; a centrifugation rate is 800-1200 rpm, and the centrifugation time is 8-15 min; and a drying temperature of the polyarylene ether nitrile powder is 50-70° C., and the drying time 20-30 min.

Further, in S7, a distillation temperature is 75-80° C., and the distillation time is 3-5 h.

Advantages of the present invention are as follows:

The present invention is used to improve the process for efficiently recovering the N-methylpyrrolidone solvent in the continuous production of polyarylene ether nitrile, and can solve the problem of difficulty in recovering the solvent in the existing polyarylene ether nitrile production process, ensuring the continuity and environmental protection of the polyarylene ether nitrile production, and reducing the production costs.

Compared with the traditional production process of polyarylene ether nitrile, the present invention solves the following four problems. 1) After the synthesis reaction is completed, there is no need to add a large amount of high boiling point solvent to dilute the reaction solution, which will not cause the interruption of production due to the occupation of the synthesis reaction kettle, and there is no waste of resources due to the use of the large amount of solvent. 2) The two-stage vibrating screens are used to realize multiple times of replacement and recovery of N-methylpyrrolidone solvent with a small amount each time, and methanol is used as a replacement solvent, has a low boiling point and is easy for separation, which can effectively ensure the high-efficiency recovery of N-methylpyrrolidone. 3) The three-stage colloid mill is used in series, which can accurately control the particle size of polyarylene ether nitrile powder, and at the same time, improve the grinding and conveying speed of polyarylene ether nitrile products, and improve the continuous production efficiency of the whole set of device. 4) Compared with the traditional extraction kettle, the present invention designs a centrifugal filter screen and electric heating auxiliary equipment suitable for the particle size of the present product on the basis of the traditional extraction kettle to endow the extraction kettle with multiple functions of extraction, centrifugation and drying, and there is no need to arrange a pipeline to convey solid powder containing a certain amount of water, simplifying the pipeline's design and process, reducing the cost of process design and eliminating hidden safety hazards in the pipeline conveyance. In summary, the process method provided by the present invention is simple, can ensure the continuity, high efficiency, low energy consumption and green environmental protection of production, and is easily universalized and popularized.

### DETAILED DESCRIPTION OF THE EMBODIMENTS

The following embodiments are intended to illustrate the present invention in detail, which are preferred embodiments and are not used for limiting the present invention. All other embodiments obtained by those skilled in the art based on the embodiments of the present invention without creative efforts shall fall with the protection scope of the present invention.

### Embodiment 1

A continuous process for producing polyarylene ether nitrile with efficiently recovering an N-methylpyrrolidone solvent includes the following steps:

S1: adding 150 mol of potassium carbonate and 100 mol of 2,6-dichlorobenzonitrile to 250 mol of N-methylpyrrolidone, and mixing well to obtain a reaction solution; and then adding 100 mol of dihydric phenol as shown in formula I and 100 mol of toluene to the reaction solution, and after mixing well, carrying out a dehydration reaction at 140° C. for 2 h, and then carrying out a polymerization reaction at 180° C. for 3 h, to obtain a high-viscosity polyarylene ether nitrile solution;

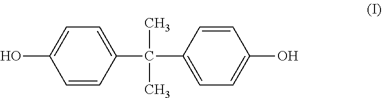 [SMILES: CC(C)(c1ccc(O)cc1)c1ccc(O)cc1]

S2: introducing the high-viscosity polyarylene ether nitrile solution obtained in S1 into an autoclave, wherein the discharge port of the autoclave is provided with a casting head, a pelletizing cutter head and a cooling spray device, starting the pelletizing cutter head and the cooling spray device, and under the action of a pressure pump, conveying the high-viscosity polyarylene ether nitrile solution to the casting head of the discharge port, and cutting it into cylindrical particles with a length of about 0.5 mm and a diameter of about 0.3 mm to obtain polyarylene ether nitrile particles;

S3: conveying the polyarylene ether nitrile particles obtained in S2 together with methanol to a primary vibrating screen for vibration, and carrying out a primary replacement and recovery of N-methylpyrrolidone, wherein a volume ratio of the methanol used to the N-methylpyrrolidone used during synthesis of polyarylene ether nitrile is 1:1;

S4: conveying a mixture after the vibration treatment of the primary vibrating screen to a secondary vibrating screen, and supplementally adding methanol for vibration, and carrying out a secondary replacement and recovery of N-methylpyrrolidone, wherein a volume ratio of the supplementally added methanol to the methanol added to the primary vibrating screen is 0.8:1; and then separating the polyarylene ether nitrile particles from a replacement liquid;

S5: mixing the polyarylene ether nitrile particles after the treatment in S4 and methanol in a mass ratio of 1:2, and then sending the mixture to a colloid mill for grinding and crushing; and after triple crushing by a three-stage colloid mill, obtaining a polyarylene ether nitrile powder slurry;

S6: conveying the polyarylene ether nitrile powder slurry obtained in S5 to a centrifuge via a pipeline, extracting with methanol at 25° C. for 10 min, and then centrifuging at 800 rpm for 8 min to separate the polyarylene ether nitrile powder from a centrifugation liquid; repeating the above operations three times; and then carrying out water washing and drying treatments on the polyarylene ether nitrile powder in sequence to obtain purified polyarylene ether nitrile powder, wherein the drying temperature is 50° C. and the drying time is 20 min; and

S7: combining the replacement liquid in S4 and the centrifugation liquid in S6, distilling at 80° C. for 3 h to remove methanol and completing the recovery of N-methylpyrrolidone.

### Embodiment 2

A continuous process for producing polyarylene ether nitrile with efficiently recovering an N-methylpyrrolidone solvent includes the following steps:

S1: adding 180 mol of potassium carbonate and 100 mol of 2,6-dichlorobenzonitrile to 300 mol of N-methylpyrrolidone, and mixing well to obtain a reaction solution; and then adding 100 mol of dihydric phenol as shown in formula II and 50 mol of toluene to the reaction solution, and after mixing well, carrying out a dehydration reaction at 150° C. for 2.5 h, and then carrying out a polymerization reaction at 185° C. for 3.5 h, to obtain a high-viscosity polyarylene ether nitrile solution;

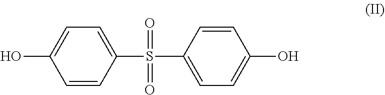 [SMILES: O=S(=O)(c1ccc(O)cc1)c1ccc(O)cc1]

S2: introducing the high-viscosity polyarylene ether nitrile solution obtained in S1 into an autoclave, wherein the discharge port of the autoclave is provided with a casting head, a pelletizing cutter head and a cooling spray device, starting the pelletizing cutter head and the cooling spray device, and under the action of a pressure pump, conveying the high-viscosity polyarylene ether nitrile solution to the casting head of the discharge port, and cutting it into cylindrical particles with a length of about 0.2 mm and a diameter of about 0.2 mm to obtain polyarylene ether nitrile particles;

S3: conveying the polyarylene ether nitrile particles obtained in S2 together with methanol to a primary vibrating screen for vibration, and carrying out a primary replacement and recovery of N-methylpyrrolidone, wherein a volume ratio of the methanol used to the N-methylpyrrolidone used during synthesis of polyarylene ether nitrile is 1.5:1;

S4: conveying a mixture after the vibration treatment of the primary vibrating screen to a secondary vibrating screen, and supplementally adding methanol for vibration, and carrying out a secondary replacement and recovery of N-methylpyrrolidone, wherein a volume ratio of the supplementally added methanol to the methanol added to the primary vibrating screen is 0.6:1; and then separating the polyarylene ether nitrile particles from a replacement liquid;

S5: mixing the polyarylene ether nitrile particles after the treatment in S4 and methanol in a mass ratio of 1:1.5, and then sending the mixture to a colloid mill for grinding and crushing; and after triple crushing by a three-stage colloid mill, obtaining a polyarylene ether nitrile powder slurry;

S6: conveying the polyarylene ether nitrile powder slurry obtained in S5 to a centrifuge via a pipeline, extracting with methanol at 24° C. for 15 min, and then centrifuging at 900 rpm for 10 min to separate the polyarylene ether nitrile powder from a centrifugation liquid; repeating the above operations three times; and then carrying out water washing and drying treatments on the polyarylene ether nitrile powder in sequence to obtain purified polyarylene ether nitrile powder, wherein the drying temperature is 55° C. and the drying time is 22 min; and

S7: combining the replacement liquid in S4 and the centrifugation liquid in S6, distilling at 75° C. for 5 h to remove methanol and completing the recovery of N-methylpyrrolidone.

### Embodiment 3

A continuous process for producing polyarylene ether nitrile with efficiently recovering an N-methylpyrrolidone solvent includes the following steps:

S1: adding 110 mol of potassium carbonate and 100 mol of 2,6-dichlorobenzonitrile to 250 mol of N-methylpyrrolidone, and mixing well to obtain a reaction solution; and then adding 100 mol of dihydric phenol as shown in formula III and 125 mol of toluene to the reaction solution, and after mixing well, carrying out a dehydration reaction at 160° C. for 3 h, and then carrying out a polymerization reaction at 190° C. for 4 h, to obtain a high-viscosity polyarylene ether nitrile solution;

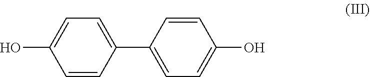 [SMILES: Oc1ccc(-c2ccc(O)cc2)cc1]

S2: introducing the high-viscosity polyarylene ether nitrile solution obtained in S1 into an autoclave, wherein the discharge port of the autoclave is provided with a casting head, a pelletizing cutter head and a cooling spray device, starting the pelletizing cutter head and the cooling spray device, and under the action of a pressure pump, conveying the high-viscosity polyarylene ether nitrile solution to the casting head of the discharge port, and cutting it into cylindrical particles with a length of about 0.5 mm and a diameter of about 0.2 mm to obtain polyarylene ether nitrile particles;

S3: conveying the polyarylene ether nitrile particles obtained in S2 together with methanol to a primary vibrating screen for vibration, and carrying out a primary replacement and recovery of N-methylpyrrolidone, wherein a volume ratio of the methanol used to the N-methylpyrrolidone used during synthesis of polyarylene ether nitrile is 1.5:1;

S4: conveying a mixture after the vibration treatment of the primary vibrating screen to a secondary vibrating screen, and supplementally adding methanol for vibration, and carrying out a secondary replacement and recovery of N-methylpyrrolidone, wherein a volume ratio of the supplementally added methanol to the methanol added to the primary vibrating screen is 0.9:1; and then separating the polyarylene ether nitrile particles from a replacement liquid;

S5: mixing the polyarylene ether nitrile particles after the treatment in S4 and methanol in a mass ratio of 1:2, and then sending the mixture to a colloid mill for grinding and crushing; and after triple crushing by a three-stage colloid mill, obtaining a polyarylene ether nitrile powder slurry;

S6: conveying the polyarylene ether nitrile powder slurry obtained in S5 to a centrifuge via a pipeline, extracting with methanol at 22° C. for 20 min, and then centrifuging at 1000 rpm for 12 min to separate the polyarylene ether nitrile powder from a centrifugation liquid; repeating the above operations three times; and then carrying out water washing and drying treatments on the polyarylene ether nitrile powder in sequence to obtain purified polyarylene ether nitrile powder, wherein the drying temperature is 60° C. and the drying time is 26 min; and

S7: combining the replacement liquid in S4 and the centrifugation liquid in S6, distilling at 75° C. for 4 h to remove methanol and completing the recovery of N-methylpyrrolidone.

### Embodiment 4

A continuous process for producing polyarylene ether nitrile with efficiently recovering an N-methylpyrrolidone solvent includes the following steps:

S1: adding 150 mol of potassium carbonate and 100 mol of 2,6-dichlorobenzonitrile to 300 mol of N-methylpyrrolidone, and mixing well to obtain a reaction solution; and then adding 100 mol of dihydric phenol as shown in formula IV and 100 mol of toluene to the reaction solution, and after mixing well, carrying out a dehydration reaction at 170° C. for 3.5 h, and then carrying out a polymerization reaction at 195° C. for 4.5 h, to obtain a high-viscosity polyarylene ether nitrile solution;

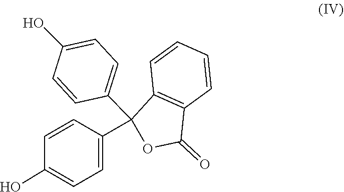 [SMILES: O=C1OC(c2ccc(O)cc2)(c2ccc(O)cc2)c2ccccc21]

S2: introducing the high-viscosity polyarylene ether nitrile solution obtained in S1 into an autoclave, wherein the discharge port of the autoclave is provided with a casting head, a pelletizing cutter head and a cooling spray device, starting the pelletizing cutter head and the cooling spray device, and under the action of a pressure pump, conveying the high-viscosity polyarylene ether nitrile solution to the casting head of the discharge port, and cutting it into cylindrical particles with a length of about 0.5 mm and a diameter of about 0.45 mm to obtain polyarylene ether nitrile particles;

S3: conveying the polyarylene ether nitrile particles obtained in S2 together with methanol to a primary vibrating screen for vibration, and carrying out a primary replacement and recovery of N-methylpyrrolidone, wherein a volume ratio of the methanol used to the N-methylpyrrolidone used during synthesis of polyarylene ether nitrile is 1:1;

S4: conveying a mixture after the vibration treatment of the primary vibrating screen to a secondary vibrating screen, and supplementally adding methanol for vibration, and carrying out a secondary replacement and recovery of N-methylpyrrolidone, wherein a volume ratio of the supplementally added methanol to the methanol added to the primary vibrating screen is 0.9:1; and then separating the polyarylene ether nitrile particles from a replacement liquid;

S5: mixing the polyarylene ether nitrile particles after the treatment in S4 and methanol in a mass ratio of 1:3, and then sending the mixture to a colloid mill for grinding and crushing; and after triple crushing by a three-stage colloid mill, obtaining a polyarylene ether nitrile powder slurry;

S6: conveying the polyarylene ether nitrile powder slurry obtained in S5 to a centrifuge via a pipeline, extracting with methanol at 20° C. for 25 min, and then centrifuging at 1100 rpm for 13 min to separate the polyarylene ether nitrile powder from a centrifugation liquid; repeating the above operations three times; and then carrying out water washing and drying treatments on the polyarylene ether nitrile powder in sequence to obtain purified polyarylene ether nitrile powder, wherein the drying temperature is 65° C. and the drying time is 28 min; and

S7: combining the replacement liquid in S4 and the centrifugation liquid in S6, distilling at 80° C. for 4 h to remove methanol and completing the recovery of N-methylpyrrolidone.

### Embodiment 5

A continuous process for producing polyarylene ether nitrile with efficiently recovering an N-methylpyrrolidone solvent includes the following steps:

S1: adding 150 mol of potassium carbonate and 100 mol of 2,6-dichlorobenzonitrile to 250 mol of N-methylpyrrolidone, and mixing well to obtain a reaction solution; and then adding 50 mol of dihydric phenol as shown in formula I, 50 mol of dihydric phenol as shown in formula III and 100 mol of toluene to the reaction solution, and after mixing well, carrying out a dehydration reaction at 140° C. for 2 h, and then carrying out a polymerization reaction at 180° C. for 3 h, to obtain a high-viscosity polyarylene ether nitrile solution;

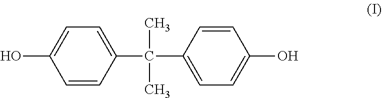 [SMILES: CC(C)(c1ccc(O)cc1)c1ccc(O)cc1]

S2: introducing the high-viscosity polyarylene ether nitrile solution obtained in S1 into an autoclave, wherein the discharge port of the autoclave is provided with a casting head, a pelletizing cutter head and a cooling spray device, starting the pelletizing cutter head and the cooling spray device, and under the action of a pressure pump, conveying the high-viscosity polyarylene ether nitrile solution to the casting head of the discharge port, and cutting it into cylindrical particles with a length of about 0.5 mm and a diameter of about 0.3 mm to obtain polyarylene ether nitrile particles;

S3: conveying the polyarylene ether nitrile particles obtained in S2 together with methanol to a primary vibrating screen for vibration, and carrying out a primary replacement and recovery of N-methylpyrrolidone, wherein a volume ratio of the methanol used to the N-methylpyrrolidone used during synthesis of polyarylene ether nitrile is 1:1;

S4: conveying a mixture after the vibration treatment of the primary vibrating screen to a secondary vibrating screen, and supplementally adding methanol for vibration, and carrying out a secondary replacement and recovery of N-methylpyrrolidone, wherein a volume ratio of the supplementally added methanol to the methanol added to the primary vibrating screen is 0.8:1; and then separating the polyarylene ether nitrile particles from a replacement liquid;

S5: mixing the polyarylene ether nitrile particles after the treatment in S4 and methanol in a mass ratio of 1:2, and then sending the mixture to a colloid mill for grinding and crushing; and after triple crushing by a three-stage colloid mill, obtaining a polyarylene ether nitrile powder slurry;

S6: conveying the polyarylene ether nitrile powder slurry obtained in S5 to a centrifuge via a pipeline, extracting with methanol at 25° C. for 10 min, and then centrifuging at 800 rpm for 8 min to separate the polyarylene ether nitrile powder from a centrifugation liquid; repeating the above operations three times; and then carrying out water washing and drying treatments on the polyarylene ether nitrile powder in sequence to obtain purified polyarylene ether nitrile powder, wherein the drying temperature is 50° C. and the drying time is 20 min; and

S7: combining the replacement liquid in S4 and the centrifugation liquid in S6, distilling at 80° C. for 3 h to remove methanol and completing the recovery of N-methylpyrrolidone.

Result Analysis

For the polyarylene ether nitrile product prepared in Embodiment 1, its thin film sample has a tensile strength of about 98 MPa, a thermal decomposition temperature (T_{5%}) of 505° C., a glass transition temperature (T_{g}) of 180° C., and a potassium ion content (specified purity) of 130 ppm, and the recovery rate of the N-methylpyrrolidone solvent is 85%.

For the polyarylene ether nitrile product prepared in Embodiment 2, its thin film sample has a tensile strength of about 102 MPa, a thermal decomposition temperature (T_{5%}) of 515° C., a glass transition temperature (T_{g}) of 185° C., and a potassium ion content (specified purity) of 132 ppm, and the recovery rate of the N-methylpyrrolidone solvent is 88%.

For the polyarylene ether nitrile product prepared in Embodiment 3, its thin film sample has a tensile strength of about 93 MPa, a thermal decomposition temperature (T_{5%}) of 512° C., a glass transition temperature (T_{g}) of 181° C., and a potassium ion content (specified purity) of 127 ppm, and the recovery rate of the N-methylpyrrolidone solvent is 82%.

For the polyarylene ether nitrile product prepared in Embodiment 4, its thin film sample has a tensile strength of about 99 MPa, a thermal decomposition temperature (T_{5%}) of 510° C., a glass transition temperature (T_{g}) of 184° C., and a potassium ion content (specified purity) of 129 ppm, and the recovery rate of the N-methylpyrrolidone solvent is 80%.

For the polyarylene ether nitrile product prepared in Embodiment 5, its thin film sample has a tensile strength of about 108 MPa, a thermal decomposition temperature (T_{5%}) of 519° C., a glass transition temperature (T_{g}) of 186° C., and a potassium ion content (specified purity) of 134 ppm, and the recovery rate of the N-methylpyrrolidone solvent is 86%.

For the polyarylene ether nitrile products prepared in Embodiments 1 to 5 described above, the tensile strength of the thin film sample indicates that a high molecular weight polyarylene ether nitrile is obtained, the thermal decomposition temperature and glass transition temperature indicate that the molecular structure is relatively regular and defect-free, and the structure is regular; and the potassium ion content indicates that the final product is high-purity polyarylene ether nitrile, and the recovery rate of the N-methylpyrrolidone solvent indicates that the process can realize the efficient recovery of the solvent.

Although the specific implementation of the present invention has been described in detail in conjunction with the embodiments, it should not be construed as limiting the protection scope of the present invention. Within the scope described in the claims, various modifications and variations made by those skilled in the art without creative efforts still fall within the protection scope of the present patent.

What is claimed is:

1. A process for producing polyarylene ether nitrile with efficiently recovering an N-methylpyrrolidone solvent, comprising the following steps:
S1: adding potassium carbonate and 2,6-dichlorobenzonitrile to N-methylpyrrolidone to obtain a first mixture, and mixing the first mixture well to obtain a reaction solution; and then adding dihydric phenol and toluene to the reaction solution to obtain a second mixture, mixing the second mixture well and then carrying out a dehydration reaction and a polymerization reaction on the second mixture in sequence to obtain a high-viscosity polyarylene ether nitrile solution;
S2: carrying out a pelletizing treatment on the high-viscosity polyarylene ether nitrile solution obtained in 51 to obtain polyarylene ether nitrile particles;
S3: conveying the polyarylene ether nitrile particles obtained in S2 together with methanol to a primary vibrating screen for a first vibration to obtain a third mixture, and carrying out a primary replacement and recovery of N-methylpyrrolidone, wherein a volume ratio of the methanol used to the N-methylpyrrolidone used during a synthesis of the high-viscosity polyarylene ether nitrile solution is 1-1.5:1;
S4: conveying the third mixture after the first vibration of the primary vibrating screen to a secondary vibrating screen, and supplementally adding methanol for a second vibration, and carrying out a secondary replacement and recovery of N-methylpyrrolidone, wherein a volume ratio of the supplementally added methanol to the methanol added to the primary vibrating screen is 0.6-0.9:1; and then separating the polyarylene ether nitrile particles from a replacement liquid;
S5: mixing the polyarylene ether nitrile particles after a treatment in S4 and methanol in a mass ratio of 1:1.5-3 to obtain a fourth mixture, and then sending the fourth mixture to a grinding device for grinding to obtain a polyarylene ether nitrile powder slurry;
S6: carrying out an extraction on the polyarylene ether nitrile powder slurry with methanol, then performing a centrifugation to separate the polyarylene ether nitrile powder slurry from a centrifugation liquid, and then carrying out water washing and drying treatments on the polyarylene ether nitrile powder slurry in sequence to obtain purified polyarylene ether nitrile powder; and
S7: combining the replacement liquid and the centrifugation liquid to obtain a fifth mixture, distilling the fifth mixture to remove methanol and completing a recovery of the N-methylpyrrolidone solvent.

2. The process according to claim 1, wherein a molar ratio of the 2,6-dichlorobenzonitrile, the dihydric phenol, the potassium carbonate, the N-methylpyrrolidone and the toluene used in S1 is 1:1:1.1-1.8:2.5-3:0.5-1.25.

3. The process according to claim 2, wherein the molar ratio of the 2,6-dichlorobenzonitrile, the dihydric phenol, the potassium carbonate, the N-methylpyrrolidone and the toluene is 1:1:1.5:2.5:1.

4. The process according to claim 1, wherein the dihydric phenol is at least one selected from the group consisting of:

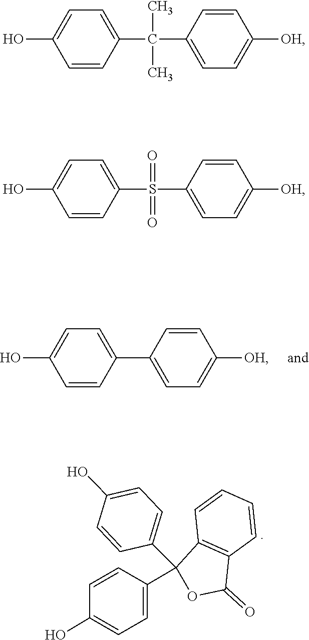

5. The process according to claim 1, wherein in S1, a reaction temperature of the dehydration reaction is 140-170° C., reaction time of the dehydration reaction is 2-4 h; and a reaction temperature of the polymerization reaction is 180-200° C., and reaction time of the polymerization reaction is 3-5 h.

6. The process according to claim 1, wherein the polyarylene ether nitrile particles are cylindrical particles with a length of 0.2-0.5 mm and a diameter of 0.2-0.45 mm.

7. The process according to claim 1, wherein a particle size of the purified polyarylene ether nitrile powder is 150-300 mesh.

8. The process according to claim 1, wherein the extraction and the centrifugation are repeated three times in S6.

9. The process according to claim 1, wherein an extraction temperature is 20-25° C., extraction time is 10-30 min; and a centrifugation rate is 800-1200 rpm, and centrifugation time is 8-15 min.

10. The process according to claim 1, wherein in S7, a distillation temperature is 75-80° C., and distillation time is 3-5 h.

11. The process according to claim 2, wherein the dihydric phenol is at least one selected from the group consisting of:

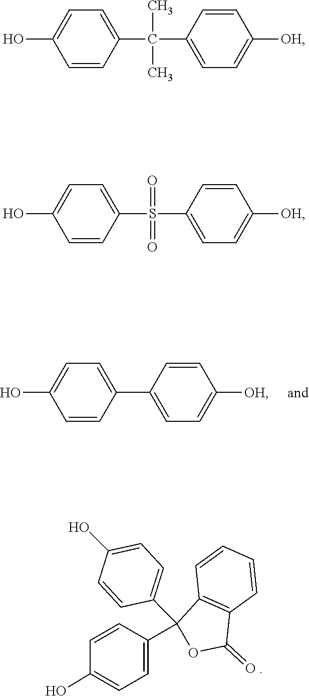

12. The process according to claim 3, wherein the dihydric phenol is at least one selected from the group consisting of:

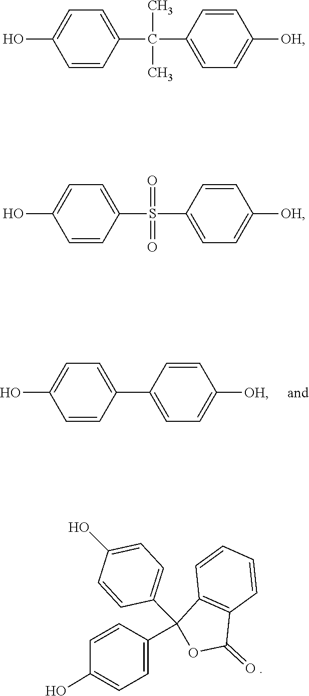

13. The process according to claim 8, wherein an extraction temperature is 20-25° C., extraction time is 10-30 min; and a centrifugation rate is 800-1200 rpm, and centrifugation time is 8-15 min.
